(19) United States
(12) Patent Application Publication
(10) Pub. No.: US 2004/0175544 A1
(43) Pub. Date: Sep. 9, 2004

(54) Non-asbestos-based friction materials

(76) Inventors: Iwao Saikatsu, Oura-gun (JP); Kunio Shibata, Oura-gun (JP); Tsuneaki Asahi, Oura-gun (JP); Motoki Hiraoka, Toyota-shi (JP); Yukio Shimokawa, Toyota-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/724,366

(22) Filed: Nov. 26, 2003

(30) Foreign Application Priority Data
Dec. 4, 2002 (JP) 2002-351988

(51) Int. Cl. B32B 1/00

(52) U.S. Cl. 428/143

(57) ABSTRACT

A non-asbestos-based friction material for rotors and brake drums of aluminum alloy for automobiles or the like, which exhibits lower counter surface attack and excellent wear resistance, produced by forming and then curing a non-asbestos-based friction material composition comprising a fibrous base (A), binder (B) and filler (C) as the major ingredients, wherein the filler (C) is incorporated with 1 to 10% of abrasive particles having an average size of 0.5 to 10 μm and 4 to 20% of unvulcanized rubber, all percentages by volume based on the whole friction material.

### BACKGROUND OF THE INVENTION

1. Field of the Invention

This invention relates to a non-asbestos-based friction material to be used for brakes, clutches or the like for automobiles, more particularly the friction material to be used for rotors or brake drums of aluminum alloy, having lower counter surface attack and excellent friction performance.

2. Description of the Prior Art

As part of the efforts to improve mileage of automobiles by reducing their weights, the brake systems of cast iron, e.g., FC250, have been generally used. At the same time, rotors and brake drums of aluminum alloy dispersed with hard, inorganic particles have been investigated. For example, brake drums of aluminum alloy dispersed with ceramic particles have been disclosed by, e.g., Japanese Patent Laid-open Publication No. 5-106666 (claims and others).

Non-asbestos-based friction materials for automobile brake systems are generally composed of a fibrous base (e.g., heat-resistant organic fibers, and metallic and inorganic fibers), binder (e.g., phenol resin) and fillers as the major base components, e.g., friction/wear modifier (e.g., graphite) and abrasive agent (e.g., alumina). A friction material for brake systems should satisfy various requirements, e.g., high resistance to wear, high and stable coefficient of friction, high resistance to fade to prevent the coefficient of friction from rapidly deteriorated at high temperature, generating little abnormal sound when the brake is applied, and lower counter surface attack (hereinafter sometimes referred to as rotor), in order to smoothly provide the services, including braking.

The rotor and brake drum of aluminum alloy dispersed with ceramic particles as hard, inorganic particles exhibit problems, because the non-asbestos-based friction material used with the conventional rotors and brake drums of cast iron may not exhibit a sufficient coefficient of friction when used with the aluminum alloy rotors and brake drums.

Therefore, non-asbestos-based friction materials having a sufficient coefficient of friction have been investigated by dispersing hard, inorganic particles therein to increase their coefficient of friction. For example, Japanese Patent Laid-open Publication No. 6-228539 (claims and others) and Japanese Patent Laid-open Publication No. 2002-97452 (claims and others) disclose non-asbestos-based friction materials dispersed with hard, inorganic particles having a Mohs hardness of 6 or more.

However, these friction materials dispersed with hard, inorganic particles, although having a high coefficient of friction, tend to suffer deteriorated properties with respect to wear resistance and attack on counter surface, among others. They have increasingly failed to satisfy the required performances, in particular improved wear resistance and lower counter surface attack, as the markets have been demanding friction materials of higher performances.

One of the proposed friction materials dispersed with ceramic particles as hard, inorganic particles for rotors and brake drums of aluminum alloy is the one composed of 5 to 80% of finely powdered abrasive alumina, 5 to 40% of an organic binder, less than 5% of granular metal, less than 5% of granular carbon and 1 to 40% of organic fibers, all percentages by volume (Japanese Patent Laid-open Publication No. 9-508420 (claims and others)). Another proposed friction material for aluminum disk rotors is composed of a mixture as a composition for friction material, comprising a base, binder and friction modifier containing hard, inorganic particles, wherein porosity is 20% or more based on 100% of the whole friction material volume, and cumulative volume of the pores having a diameter of 1 μm or more is 2% or less (Japanese Patent Laid-open Publication No. 2002-97451 (claims and others)). Still another proposed friction material is a molded composition composed of fibers as the base, a binder, friction modifier and filler, and is used in combination with a rotor of aluminum alloy, characterized in that the friction modifier is composed of hard, inorganic particles and a solid lubricant, which are granulated via a binder of thermosetting resin, and dispersed in the friction material (Japanese Patent Laid-open Publication No. 2002-97452 (claims and others)).

In spite of these proposals, however, there is no friction material which has a sufficient coefficient of friction, lower counter surface attack and excellent wear resistance for rotors and brake drums of aluminum alloy.

Therefore, there are strong demands for non-asbestos-based friction materials having lower counter surface attack and excellent wear resistance for rotors and brake drums of aluminum alloy.

### SUMMARY OF THE INVENTION

It is an object of the present invention to provide a non-asbestos-based friction material having lower counter surface attack and excellent wear resistance for rotors and brake drums of aluminum alloy for automobiles or the like.

The inventors of the present invention have noted, after having extensively studied to overcome the problems involved in the conventional techniques, utilizing hard, inorganic particles as a filler for increasing coefficient of friction of a non-asbestos-based friction material for rotors and brake drums of aluminum alloy, that a non-asbestos-based friction material exhibits high wear resistance and lower counter surface attack, when the non-asbestos-based friction material composition is simultaneously incorporated with an adequate quantity of abrasive particles having an average size of around several microns and unvulcanized rubber working as a lubricant while relaxing the abrasive actions of the abrasive particles. The present invention has been developed, based on the above knowledge.

The first aspect of the present invention is a non-asbestos-based friction material for rotors and brake drums of aluminum alloy, produced by forming and then curing a non-asbestos-based friction material composition comprising a fibrous base (A), binder (B) and filler (C) as the major ingredients, wherein the filler (C) is incorporated with 1 to 10% of abrasive particles having an average size of 0.5 to 10 μm and 4 to 20% of unvulcanized rubber, all percentages by volume based on the whole friction material.

The second aspect of the present invention is the non-asbestos-based friction material of the first aspect, wherein the abrasive particles have a Mohs hardness of 6 or more.

The third aspect of the present invention is the non-asbestos-based friction material of the first or second aspect, wherein the abrasive particles are at least of one material selected from the group consisting of silicon carbide, alumina, silica, zirconia, magnesia, zirconium silicate and silica/alumina-based ceramic.

The fourth aspect of the present invention is the non-asbestos-based friction material of the first aspect, wherein the unvulcanized rubber is at least of one selected from the group consisting of natural rubber, isoprene rubber (IR), nitrile/butadiene rubber (NBR), styrene/butadiene rubber (SBR), butadiene rubber (BR), chloroprene rubber (CR), butyl rubber (IIR), ethylene/propylene rubber (EPM or EPDM), urethane rubber, silicone rubber, fluorine rubber and acrylic rubber.

The fifth aspect of the present invention is the non-asbestos-based friction material of the fourth aspect, wherein the unvulcanized rubber is at least of one selected from the group consisting of nitrile/butadiene rubber (NBR) and styrene/butadiene rubber (SBR).

As described above, the present invention relates to a non-asbestos-based friction material for rotors and brake drums of aluminum alloy, produced by forming and then curing a non-asbestos-based friction material composition comprising a fibrous base (A), binder (B) and filler (C) as the major ingredients, wherein the filler (C) is incorporated with 1 to 10% of abrasive particles having an average size of 0.5 to 10 μm and 4 to 20% of unvulcanized rubber, all percentages by volume based on the whole friction material. The preferred embodiments of the invention include the following:

(1) The non-asbestos-based friction material of the first aspect, wherein the fibrous base (A) is at least one fibrous base material selected from the group consisting of aramid and potassium titanate fibers.

(2) The non-asbestos-based friction material of the first aspect, wherein the binder (B) is a thermosetting resin.

(3) The non-asbestos-based friction material of the above (2), wherein the thermosetting resin is a phenol resin.

(4) The non-asbestos-based friction material of the third aspect, wherein the abrasive particles are silicon carbide.

### DETAILED DESCRIPTION OF THE INVENTION

The present invention is described in detail for each item.

The present invention relates to a non-asbestos-based friction material produced by forming and then curing a non-asbestos-based friction material composition comprising a fibrous base (A), binder (B) and filler (C) as the major ingredients, wherein the filler (C) is incorporated with 1 to 10% of abrasive particles having an average size of 0.5 to 10 μm and 4 to 20% of unvulcanized rubber, all percentages by volume based on the whole friction material, and is used for rotors and brake drums of aluminum alloy.

1. Fibrous Base (A)

The fibrous base (A) for the non-asbestos-based friction material of the present invention is not limited, so long as it is free of asbestos. It may be composed of organic, inorganic or metallic fibers, which have been commonly used for friction materials.

The organic fibers useful for the present invention include Aramid, carbon, cellulose and acrylic fibers. The inorganic fibers include those of glass, potassium titanate, ceramic, wollastonite and sepiolite. The metallic fibers include those of steel, stainless steel, bronze, brass and aluminum. They may be used either individually or in combination. Of these, Aramid and potassium titanate fibers are more preferable.

In the present invention, the materials used for the fibrous base (A) are in the short fiber or pulp-shaped. Its percentage of the total composition is not limited, and should be adequately selected for the specific component. It is normally around 2 to 30% by volume based on the whole non-asbestos-based friction material composition, preferably 5 to 20%.

2. Binders (B)

The binder (B) for the non-asbestos-based friction material of the present invention is selected from the known ones commonly used for friction materials. They include thermosetting resins, e.g., phenolic, epoxy, urea, melamine resin and modifications thereof, heat-resistant resins, e.g., polyacetal, aromatic polyimide and fluorine resin. They may be used either individually or in combination.

In the present invention, the percentage of binder (B) in the total composition is not limited, and should be adequately selected for the specific component. It is normally around 5 to 40% by volume based on the whole non-asbestos-based friction material composition, preferably 10 to 30%.

3. Fillers (C)

The filler (C) in the composition for the non-asbestos-based friction material of the present invention is composed of abrasive particles having an average size of 0.5 to 10 μm used in combination with unvulcanized rubber, which is its major characteristic.

The inventors of the present invention consider the following mechanisms to be those by which the filler (C) exhibits its function, although this has not been fully substantiated.

A friction material incorporated with abrasive particles but not unvulcanized rubber tends to have deteriorated properties with respect to wear resistance and attack on counter surface, although it exhibits a high coefficient of friction.

The deteriorated property with respect to attack on counter surface results from the abrasive particles exposed on the friction material surface, rubbing the rotor or drum surface with which they come into contact.

On the other hand, a friction material incorporated with abrasive particles and unvulcanized rubber simultaneously has lower counter surface attack and improved wear resistance, the former conceivably resulting from the unvulcanized rubber covering the abrasive particles and keeping them unexposed to the friction material surface, thus reducing their abrasive actions, and the latter conceivably from a lubricating phenomenon between the abrasive particles and the unvulcanized rubber.

(1) Abrasive Particles

The abrasive particles in the composition for the non-asbestos-based friction material of the present invention may be those of metallic carbide, e.g., silicon carbide (SiC); or ceramic-based material, e.g., alumina (Al₂O₃), silica (silicon dioxide, SiO₂), zirconia (zirconium oxide, ZrO2), magnesia (magnesium oxide, MgO), zirconium silicate or silica/alumina-based ceramic, each working as an abrasive. They may be used either individually or in combination. The term “abrasive” means the rubbing of a friction surface by hard projections or particles of foreign substance, and the “abrasive particles” in the present invention are those particles having abrasive actions on the friction material or counter surface with which they come into contact.

The abrasive particles which have an average size below 0.51 μm may deteriorate the stability of the coefficient of friction of the composition. On the other hand, those having an average size of above 10 μm may deteriorate the improved-property with respect to attack on counter surface.

The abrasive particles preferably have a Mohs hardness of 6 or more, particularly preferably 8 or more, because hard, inorganic particle materials for reinforcing a rotor, drum or the like of aluminum alloy generally have a Mohs hardness of 6 or more, and the abrasive particles as the friction material component are preferably harder than the corresponding aluminum alloy.

The percentage of the abrasive particles in the present invention is around 1 to 10% by volume based on the whole non-asbestos-based friction material composition. When present at below 1%, the abrasive particles may deteriorate the stability of the coefficient of friction of the composition. When present at above 10%, on the other hand, they may deteriorate the improved property with respect to attack on counter surface.

(2) Unvulcanized Rubber

The unvulcanized rubber, or rubber which is not crosslinked, in the composition for the non-asbestos-based friction material of the present invention is at least of one type selected from the group consisting of natural rubber, isoprene rubber (IR), nitrile/butadiene rubber (NBR), styrene/butadiene rubber (SBR), butadiene rubber (BR), chloroprene rubber (CR), butyl rubber (IIR), ethylene/propylene rubber (EPM or EPDM), urethane rubber, silicone rubber, fluorine rubber and acrylic rubber. Nitrile/butadiene rubber (NBR) is sometimes referred to as nitrile rubber or acrylonitrile/butadiene copolymer rubber, and styrene/butadiene rubber (SBR) is sometimes referred to as styrol rubber and is a butadiene/styrene copolymer rubber. Ethylene/propylene rubber may be an ethylene/propylene copolymer rubber (EPM or EPR) or ethylene/propylene/diene copolymer rubber (EPDM) as a 3-compponent ethylene/propylene copolymer incorporated with a non-conjugated diene as a third component. Of these, nitrile/butadiene rubber (NBR) and styrene/butadiene rubber (SBR) are particularly preferable, because they are more resistant to heat and wear than others and hence can form a film covering the abrasive particles more easily.

In the present invention, the percentage of the unvulcanized rubber is around 4 to 20% by volume based on the whole non-asbestos-based friction material composition. At below 4%, it may not fully exhibit its effect with the abrasive particles, and hence may not improve the properties of the friction material with respect to attack on counter surface and wear resistance. At above 20%, on the other hand, the friction material may be cracked while being formed.

(3) Other Filler Components

The non-asbestos-based friction material of the present invention may be incorporated with one or more filler components, within limits not harmful to the effect of the present invention. It may be organic or inorganic, and selected from commonly used friction materials. The filler components useful for the present invention include molybdenum disulfide, antimony trisulfide, calcium carbonate, barium sulfate, cashew dust, melamine dust, zeolite, coke, carbon black, graphite, calcium hydroxide, calcium fluoride, talc, molybdenum trioxide, antimony trioxide, iron oxide, mica, kaolin, iron sulfide, lead sulfide, tin sulfide, powdered metal, powdered rubber, chromium oxide, vermiculite and phosphorus-based lubricant. Of these, those having lubricity, e.g., molybdenum disulfide, antimony trisulfide, graphite and phosphorus-based lubricant, contribute to improved wear resistance and lower counter surface attack, and conversely those having an abrasive effect, e.g., iron oxide and chromium oxide, contribute to improved friction characteristics. They may be used either individually or in combination.

The percentage of other filler components is not limited for the present invention, and should be adequately selected for the specific component. It is normally around 5 to 60% by volume based on the whole non-asbestos-based friction material composition, preferably 20 to 50%.

The filler (C) is preferably incorporated with a metallic component at 0.1 to 30% by volume. Specifically, the metallic components useful for the present invention include powdered metallic elements, e.g., aluminum, copper, iron and tin; and powdered alloys of 2 or more components with the above metal serving as the base, e.g., powdered aluminum/silicon-based and aluminum/copper-based alloy. Of these, powdered aluminum and its alloy are more preferable.

The non-asbestos-based friction material still improves properties with respect to lower counter surface attack and wear resistance, when incorporated with the above metallic component.

4. Method of producing the non-asbestos-based friction material

In the method of the present invention for producing the non-asbestos-based friction material, the components, e.g., the fibrous base (A), binder (B) and filler (C), are uniformly mixed by a mixer, e.g., Henschel, Loedige or Eirich mixer, to produce the powder mixture to be formed, which is preliminarily formed in a forming mold, and then formed into a shape at 130 to 200° C. and 100 to 1000 Kg/cm² for 2 to 15 minutes.

The formed shape is heat treated at 140 to 250° C. for 2 to 48 hours (after curing), and, as required, spray-painted, baked and ground to produce the final product.

When the disk pad for automobiles or the like is to be produced, an iron or aluminum plate is washed, surface-treated and coated with an adhesive agent beforehand than placed as the back plate on the preliminarily formed shape, and the resultant assembly is formed in a forming mold, heat treated, spray-painted, baked and ground.

The non-asbestos-based friction material of the present invention can be suitably used for various purposes, e.g., brake lining, clutch facing, disk pads and brake blocks for automobiles. It exhibits lower counter surface attack and excellent wear resistance, particularly noted when it is used for a rotor or drum of aluminum alloy.

### EXAMPLES

The present invention is described in more detail by EXAMPLES and COMPARATIVE EXAMPLES, which by no means limit the present invention.

In EXAMPLES and COMPARATIVE EXAMPLES, stability of coefficient of friction, extent of attack on counter surface and wear resistance were evaluated by a test piece tester with a scale of 1/10 under the conditions of braking initial speed: 100 km/hour, braking deceleration speed: 0.3 g, number of braking cycles: 1000, brake temperature before braking: 250° C., inertia: 0.25 kg m², and test piece area: 9.42 cm². It was evaluated according to the following standard for each evaluation item. It was also evaluated for moldability by observing whether it cracked during the molding step.

[Stability of Coefficient of Friction]

Stability of coefficient of friction was evaluated by the ratio of the maximum to minimum level (Max. μ/Min. μ).

o: Max. μ/Min. μ: less than 2

x: Max. μ/Min. μ: 2 or more

[Extent of Attack on Counter Surface]

Extent of wear on the counter surface (rotor) was evaluated by observing whether or not a scar was left.

o: No scar observed

x: Scar(s) observed

[Wear Resistance]

Extent of wear of the test piece was evaluated.

⊚: 0.1 mm or less

o: More than 0.1 mm but less than 0.15 mm

x: 0.15 mm or more

[Moldability]

Moldability was evaluated by observing whether the test piece cracked during the molding step.

o: Not cracked

x: Cracked

### [EXAMPLES 1 to 8 and COMPARATIVE EXAMPLES 1 to 6]

The components for each of the friction material compositions given in Table 1, comprising the fibrous base, binder and filler, were uniformly mixed by a Loedige mixer, and preliminarily formed under pressure of 100 kg/cm² for 1 minute in a pressure mold. The preliminarily formed shape was then submitted to a temperature of 160° C. and pressure of 250 kg/cm² for an optional time, and then heat treated at 200° C. for 5 hours (after curing), to produce the test piece of non-asbestos-based friction material for each of EXAMPLES 1 to 8 and COMPARATIVE EXAMPLES 1 to 6. Each test piece was subjected to the tests by a test piece tester with a scale of 1/10. The results are given in Table 1.

TABLE 1

| Friction material compositions | | EXAMPLES | | | | | | | | COMPARATIVE EXAMPLES | | | | | |
|---|---|---|---|---|---|---|---|---|---|---|---|---|---|---|---|
| (components) | | 1 | 2 | 3 | 4 | 5 | 6 | 7 | 8 | 1 | 2 | 3 | 4 | 5 | 6 |
| Contents | Fibrous base (A): Aramid Fibers | 10 | 10 | 10 | 10 | 10 | 10 | 10 | 10 | 10 | 10 | 10 | 10 | 10 | 10 |
| (% by volume) | Binder (B): Phenolic Resin | 20 | 20 | 20 | 20 | 20 | 20 | 20 | 20 | 20 | 20 | 20 | 20 | 20 | 20 |
| | Filler (C): Cashew Dust | 10 | 10 | 10 | 10 | 10 | 10 | 10 | 10 | 10 | 10 | 10 | 10 | 10 | 10 |
| | Filler (C): Tire Rubber Particles | 5 | 5 | 5 | 5 | 5 | 5 | 5 | 5 | 5 | 5 | 5 | 5 | 5 | 5 |
| | Filler (C): Calcium Carbonate | 40 | 31 | 40 | 31 | 24 | 15 | 24 | 15 | 31 | 24 | 40.5 | 10 | 42 | 14 |
| | Filler(C): Graphite | 5 | 5 | 5 | 5 | 5 | 5 | 5 | 5 | 5 | 5 | 5 | 5 | 5 | 5 |
| | Filler(C): Aluminum Particles | 5 | 5 | 5 | 5 | 5 | 5 | 5 | 5 | 5 | 5 | 5 | 5 | 5 | 5 |
| | Abrasive Particles | | | | | | | | | | | | | | |
| | Silicon Carbide: | — | — | — | — | — | — | — | — | 10 | — | — | — | — | — |
| | Particle Size: 0.2 μm | | | | | | | | | | | | | | |
| | Silicon Carbide: | 1 | 10 | — | — | 1 | 10 | — | — | — | — | — | — | 1 | — |
| | Particle Size: 0.5 μm | | | | | | | | | | | | | | |
| | Silicon Carbide: | — | — | 1 | 10 | — | — | 1 | 10 | — | — | 0.5 | 15 | — | 1 |
| | Particle Size: 10 μm | | | | | | | | | | | | | | |
| | Silicon Carbide: | — | — | — | — | — | — | — | — | — | 1 | — | — | — | — |
| | Particle Size: 15 μm | | | | | | | | | | | | | | |
| | Unvulcanized Rubber(NBR) | 4 | 4 | 4 | 4 | 20 | 20 | 20 | 20 | 4 | 20 | 4 | 20 | 2 | 30 |

| Total Composition (% by volume) | 100 | 100 | 100 | 100 | 100 | 100 | 100 | 100 | 100 | 100 | 100 | 100 | 100 | 100 |
|---|---|---|---|---|---|---|---|---|---|---|---|---|---|---|
| Evaluation of Friction Material | | | | | | | | | | | | | | |
| Stability of Coefficient of Friction | ◯ | ◯ | ◯ | ◯ | ◯ | ◯ | ◯ | ◯ | X | ◯ | X | ◯ | ◯ | — |
| Counter Surface Attack | ◯ | ◯ | ◯ | ◯ | ◯ | ◯ | ◯ | ◯ | ◯ | X | ◯ | X | X | — |
| Wear Resistance | ◯ | ◯ | ◯ | ◯ | ⊚ | ⊚ | ⊚ | ⊚ | ◯ | ⊚ | ◯ | ⊚ | X | — |
| Moldability | ◯ | ◯ | ◯ | ◯ | ◯ | ◯ | ◯ | ◯ | ◯ | ◯ | ◯ | ◯ | ◯ | X |

As shown in Table 1, the friction material prepared in COMPARATIVE EXAMPLE 1, incorporated with abrasive particles having a size below the specified range, and that prepared in COMPARATIVE EXAMPLE 3, incorporated with abrasive particles having a size within the specified range but at a content below the specified range, exhibited insufficient stability of coefficient of friction. The friction material prepared in COMPARATIVE EXAMPLE 2, incorporated with abrasive particles having a size above the specified range, and that prepared in COMPARATIVE EXAMPLE 4, incorporated with abrasive particles having a size within the specified range but at a content above the specified range, exhibited insufficient properties with respect to attack on counter surface. The friction material prepared in COMPARATIVE EXAMPLE 5, incorporated with unvulcanized rubber at a content below the specified range, exhibited insufficient properties with respect to attack on counter surface and wear resistance, and that prepared in COMPARATIVE EXAMPLE 6, incorporated with unvulcanized rubber at a content above the specified range, exhibited insufficient moldability, because it was cracked during the molding step. By contrast, each of the friction materials of the present invention prepared in EXAMPLES 1 to 8, incorporated with abrasive particles having a size within the specified range at a content within the specified range and with unvulcanized rubber at a content within the specified range, exhibited good properties with respect to stability of coefficient of friction, attack on counter surface, wear resistance and moldability.

The non-asbestos-based friction material of the present invention for rotors and drums of aluminum alloy comprising a filler (C), incorporated with abrasive particles having an average size of 0.5 to 10 mm at 1 to 10% by volume and with unvulcanized rubber at 4 to 20% by volume, exhibits notable advantages of lower counter surface attack and excellent wear resistance, and hence is of high quality. As such, it can be suitably used for brakes, clutches or the like for automobiles or the like.

What is claimed is:

1. A non-asbestos-based friction material comprising a fibrous base (A), binder (B) and filler (C) as the major ingredients, wherein the filler (C) is incorporated with 1 to 10% of abrasive particles having an average size of 0.5 to 10 μm and 4 to 20% of unvulcanized rubber, all percentages by volume based on the whole friction material.

2. The non-asbestos-based friction material according to claim 1, wherein said abrasive particles have a Mohs hardness of 6 or more.

3. The non-asbestos-based friction material according to claim 1 or 2, wherein said abrasive particles are at least of one material selected from the group consisting of silicon carbide, alumina, silica, zirconia, magnesia, zirconium silicate and silica/alumina-based ceramic.

4. The non-asbestos-based friction material according to claim 1, wherein said unvulcanized rubber is at least of one selected from the group consisting of natural rubber, isoprene rubber (IR), nitrile/butadiene rubber (NBR), styrene/butadiene rubber (SBR), butadiene rubber (BR), chloroprene rubber (CR), butyl rubber (IIR), ethylene/propylene rubber (EPM or EPDM), urethane rubber, silicone rubber, fluorine rubber and acrylic rubber.

5. The non-asbestos-based friction material according to claim 4, wherein said unvulcanized rubber is at least of one selected from the group consisting of nitrile/butadiene rubber (NBR) and styrene/butadiene rubber (SBR).
